(19) United States
(12) Patent Application Publication
(10) Pub. No.: US 2003/0177166 A1
(43) Pub. Date: Sep. 18, 2003

(54) Scalable scheduling in parallel processors

(75) Inventors: Thomas G. Robertazzi, Mastic, NY (US); Hyoung-Joong Kim, Seocho (KR); Jui-Tsun Hung, Stony Brook, NY (US)

Correspondence Address: Frank Chau, F. CHAU & ASSOCIATES, LLP, Suite 501, 1900 Hempstead Turnpike, East Meadow, NY, 11554, US

(73) Assignee: Research Foundation of the State University of New York

(21) Appl. No.: 10/390,088

(22) Filed: Mar. 17, 2003

Related U.S. Application Data
(60) Provisional application No. 60/365,015, filed on Mar. 15, 2002.

(51) Int. Cl. G06F 9/00

(52) U.S. Cl. 709/105

(57) ABSTRACT

A method for scalably scheduling a processing task in a tree network, comprises collecting system parameters, scalably scheduling load allocations of the processing task, distributing, simultaneously, scheduled load to one or more processors from a root processor. The method further comprises processing scheduled load on the one or more processors, and reporting results of a processed schedule load to the root processor.

This application claims the benefit of U.S. Provisional Application No. 60/365,015, filed Mar. 15, 2002.

The U.S. Government has a paid-up license in this invention and the right in limited circumstances to requires the patent owner to license others on reasonable terms as provided for by the terms of Grant No. CCR9912331 awarded by the National Science Foundation.

### BACKGROUND OF THE INVENTION

1. Field of the Invention

The present invention relates to a system and method for scheduling parallel processors, and more particularly to a load distribution controller for scheduling metacomputers in a scalable manner.

2. Discussion of Related Art

It is well known that when divisible load is distributed sequentially from parent nodes in a multilevel tree to all of its children, speedup quickly saturates as the size of the tree increases (either in terms of the height of the tree and/or the number of children per parent node).

Applications that process large amounts of data on distributed and parallel networks are becoming more and more common. These applications include, for example, large scientific experiments, database applications, image processing, and sensor data processing. A number of researchers have mathematically modeled such processing using a divisible load scheduling model, which is useful for data parallelism applications.

Divisible loads are ones that consist of data that can be arbitrarily partitioned among a number of processors interconnected through some network. Divisible load modeling assumes no precedence relations amongst the data. Due to the linearity of the divisible model, optimal scheduling strategies under a variety of environments have been devised.

The majority of the divisible load scheduling literature has appeared in computer engineering periodicals. However, divisible load modeling is of interest to the networking community as it models, both computation and network communication in a completely seamless, integrated manner, and it is tractable with its linearity assumption.

Divisible load scheduling has been used to accurately and directly model such features as specific network topologies, computation versus communication load intensity, time varying inputs, multiple job submission, and monetary cost optimization.

However, researchers have noted an important performance saturation limit. If speedup (or solution time) is considered as a function of the number of processors, an asymptotic constant is reached as the number of processors is increased. Beyond a certain point, adding processors results in minimal performance improvement, and are therefore not scalable.

In a linear daisy chain, the saturation limit is typically explained by noting that, if load originates at a processor at a boundary of the chain, data needs to be transmitted and retransmitted i−1 times from processor to processor before it arrives at the ith processor (assuming a node with store and forward transmission). However, for subsequent interconnection topologies considered (e.g. bus, single level tree, hypercube), the reason for this lack of scalability has been less obvious.

Network saturation can occur when a node distributes load sequentially to one of its children at a time. This is true for both single and multi-installment scheduling strategies. Therefore, a need exists for a system and method for a load distribution controller for scheduling metacomputers in a scalable manner.

### SUMMARY OF THE INVENTION

According to an embodiment of the present invention, a method for scalably scheduling a processing task in a tree network, comprises collecting system parameters, scalably scheduling load allocations of the processing task, distributing, simultaneously, scheduled load to one or more processors from a root processor. The method further comprises processing scheduled load on the one or more processors, and reporting results of a processed schedule load to the root processor.

System parameters comprise network topology. System parameters comprise an intensity of the processor task, wherein the processor task comprises one of a computation task and a communication task. System parameters comprise a determined number of individual processors available. System parameters comprise a determined link speed between levels. System parameters comprise a determined processor speed between levels.

Scalably scheduling load allocations of the task comprises identifying a lowest level of the tree network, and replacing the lowest level with an equivalent processor. Scalably scheduling load allocations of the task comprises identifying each level of the tree network recursively up the tree network, replacing each level upon identification with an equivalent processor, and replacing the equivalent processors with a single processor upon identification of a root processors.

According to an embodiment of the present invention, a program storage device is provided, readable by machine, tangibly embodying a program of instructions executable by the machine to perform method steps for scalably scheduling a processing task in a tree network.

According to an embodiment of the present invention, a tree network having has m+1 processors and m links, comprises a plurality of children processors, and an intelligent root, connected to each of the children processor via the links, for receiving a divisible load, partitioning a total processing load into m+1 fractions, keeping a fraction, and distributing remaining fractions to the children processors concurrently.

Each processor begins computing upon receiving a distributed fraction of the divisible load.

Each processor computes without any interruption until all of the distributed fraction of the divisible load has been processed.

All of the processors in the tree network finish computing at the same time.

### BRIEF DESCRIPTION OF THE DRAWINGS

Preferred embodiments of the present invention will be described below in more detail, with reference to the accompanying drawings:

FIG. 1 is a system according to an embodiment of the present invention;

FIG. 2 is a homogeneous multi-level fat tree with intelligent root according to an embodiment of the present invention;

FIG. 3 is a heterogeneous single level fat tree, level i+1, with intelligent root according to an embodiment of the present invention;

FIG. 4 is a timing diagram of single level fat tree, level i+1, with intelligent root according to an embodiment of the present invention;

FIG. 5 is a timing diagram of multi-level fat tree using store and forward switching according to an embodiment of the present invention;

FIG. 6 is level 1 of multi-level fat tree with intelligent root according to an embodiment of the present invention;

FIG. 7 is level k of multi-level fat tree with intelligent root according to an embodiment of the present invention;

FIG. 8 is level 2 of multi-level fat tree with intelligent root according to an embodiment of the present invention;

FIG. 9 is a flow chart illustration of a method according to an embodiment of the present invention; and

FIG. 10 is a flow chart illustration of a fat tree network processing method according to an embodiment of the present invention.

### DETAILED DESCRIPTION OF PREFERRED EMBODIMENTS

According to an embodiment of the present invention, in a single level tree (e.g., star topology), if a processor can distribute load to all of its children concurrently, the speedup is a linear function of the number of processors. The scalability limitation is a proportionality constant, which depends on system parameters, and the ability of a processor to distribute loads concurrently to all of its outgoing links. Further, the trees, single and multi-level, may be spanning trees that distribute load to some or all of the nodes in some network topology using a subset of the network links forming the spanning tree. The spanning tree may thus be embedded in such network topologies as hypercubes, barrel shifters, or other interconnection topologies.

This application claims the benefit of U.S. Provisional Application No. 60/365,015, filed Mar. 15, 2002, the subject matter of which is herein incorporated by reference in its entirety.

The concurrent or simultaneous communications can be accomplished through multiple output buffers, one for each outgoing link, which are continually loaded. This higher utilization leads directly to significantly faster solutions. Further, computers with multiple (VLSI) processors having multiple front-end processors, one for each link, can allow for the simultaneous communications capabilities.

According to an embodiment of the present invention, a broadcasting mechanism, a broadcast type (e.g., sequentially or simultaneously) and the use of simultaneous broadcasting leads to scalability. The principles disclosed herein are applicable to, for example, the design of cluster computers, networks of workstations or parallel processors used for distributed computing. According to an embodiment of the present invention, an unlimited number of nodes can be connected to a source distributing loads. Since performance is not limited, the system can build as large and as fast a system as desired.

The present invention can implement cost accounting techniques needed for future metacomputing services attempting to price the cost of their services. These techniques are described in U.S. Pat. Nos. 5,889,989 and 6,370,560, incorporated herein by reference in their entirety.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

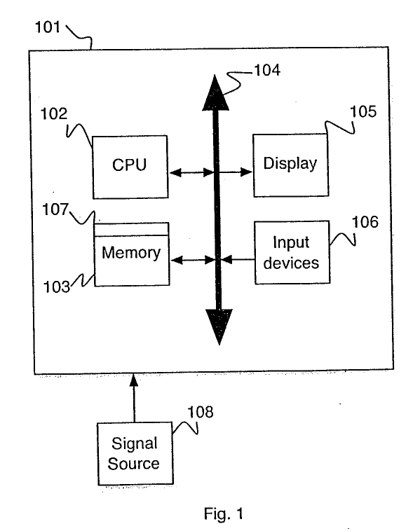

Referring to FIG. 1, according to an embodiment of the present invention, a computer system 101 for implementing the present invention can comprise, inter alia, a central processing unit (CPU) 102, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 102 to process the signal from the signal source 108. As such, the computer system 101 is a general purpose computer system that becomes a specific purpose computer system when executing the routine 107 of the present invention.

The computer platform 101 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

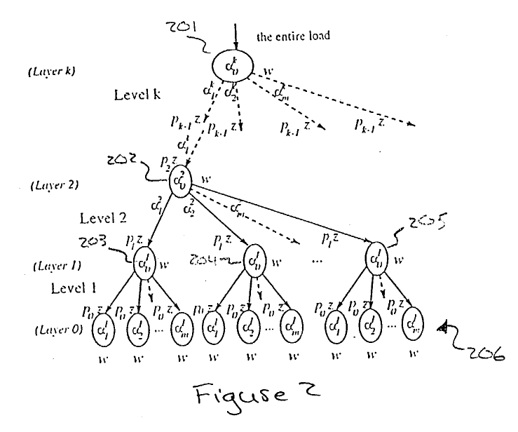

According to an embodiment of the invention, a homogeneous multi-level fat tree network where root processors are equipped with a front-end processor for off-loading communications is considered. As shown in FIG. 2, root nodes 201-205, called intelligent roots, process a fraction of the load as well as distribute the remaining load to their children processors 206.

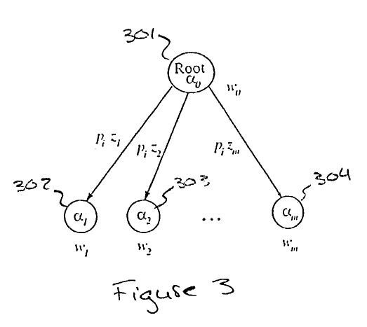

A heterogeneous single level fat tree, level i+1, with intelligent root is described as follows. All the children processors are connected to the root (parent) processor via communication links. FIG. 3 shows that an intelligent root processor 301 processes a fraction of the load as well as distributes the remaining load to its children processors 302-304.

Note that each child processor starts computing and transmitting immediately after receiving its assigned fraction of load and continues without any interruption until all its assigned load fraction have been processed. This is a store and forward mode of operation for computation and communication. The root can begin processing at time 0, the time when all the load is assumed to be present at the root.

The notations for a single heterogeneous tree are

αₒ: The load fraction assigned to the root processor.

αᵢ: The load fraction assigned to the i^{th} link-processor pair.

wᵢ: The inverse of the computing speed of the i^{th} processor.

zᵢ: The inverse of the link speed of the i^{th} link.

T_{cp}: Computing intensity constant. The entire load can be processed in wᵢT_{cp} seconds on the i^{th} processor.

T_{cm}: Communication intensity constant. The entire load can be transmitted in zᵢT_{cm} seconds over the i^{th} link.

T_{f}: The finish time. Time at which the last processor accomplishes computation.

Therefore, αᵢwᵢT_{cp} is the time to process the fraction αᵢ of the entire load on the ith processor. Note that the units of αᵢwᵢT_{cp} are [load]×[sec/load]×[dimensionless quantity].

For a multi-level homogeneous fat tree, the notations are:

αₒ^{j}: The load fraction assigned to the root processor of an equivalent j^{th} level tree.

αᵢ^{j}: The load fraction assigned to the i^{th} link-processor pair on an equivalent j^{th} level tree.

w_{eqi}: The inverse of the equivalent computing speed of the i^{th} level tree (from level i descending to level l).

pᵢ: The multiplier of the inverse of expanded capacity of the links of level i+1 with respect to the inverse of capacity of the links on level 1. The value of the multiplier, pᵢ, is the inverse of the total number of children processors descended from this link. Thus, pᵢ=(Σⱼ₌₀ⁱm^{j})⁻¹, and 0<pᵢ≦1.

The following assumptions are initially made: the interconnection network used is a star network (single level tree network). The computing and communication loads are divisible (e.g., perfectly partitioned with no precedence constraints). Transmission and computation time are proportional (linear) to the size of the problem. Each node transmits load simultaneously to its children. Store and forward is the method of transmission from level to level.

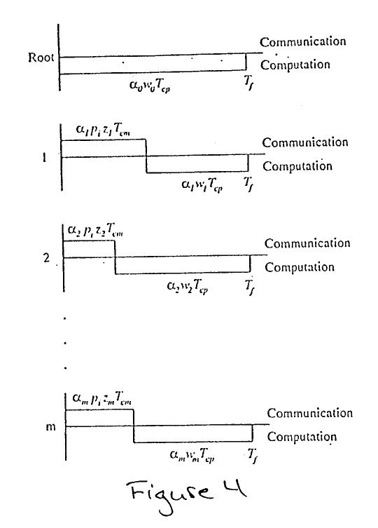

Referring now to FIG. 3, in a single level tree network, level i+1, with intelligent root, which has m+1 processors and m links, all children processors 302-304 are connected to the root processor 301 via direct communication links. The intelligent root processor 301, assumed to be the only processor at which the divisible load arrives, partitions a total processing load into m+1 fractions, keeps its own fraction αₒ, and distributes the other fractions α₁, α₂ . . . , αₘ to the children processors respectively and concurrently. Each processor begins computing upon receiving its assigned fraction of load and continues without any interruption until all of its assigned load fraction has been processed. To minimize the processing finish time, all of the utilized processors in the network need to finish computing at the same time. The process of load distribution can be represented by Gantt chart-like timing diagrams, as illustrated in FIG. 4. Note that this is a completely deterministic model.

From the timing diagram shown in FIG. 4, an equation for the root and 1^{st} child's solution time can be written as:

α₀w₀T_{cp}=α₁p₁z₁Tₑₘ+α₁w₁T_{cp} (1)

The fundamental recursive equations of the system can be formulated as follows:

$$\begin{matrix}{α}_{1} {p}_{i} {z}_{1} {T}_{c m} + {α}_{1} {w}_{1} {T}_{cp} = {α}_{2} {p}_{i} {z}_{2} {T}_{c m} + {α}_{2} {w}_{2} {T}_{cp} & ( 2 ) \\ {α}_{i - 1} {p}_{i} {z}_{i - 1} {T}_{c m} + {α}_{i - 1} {w}_{i - 1} {T}_{cp} = {α}_{i} {p}_{i} {z}_{i} {T}_{c m} + {α}_{i} {w}_{i} {T}_{cp} & ( 3 ) \\ {α}_{m - 1} {p}_{i} {z}_{m - 1} {T}_{c m} + {α}_{m - 1} {w}_{m - 1} {T}_{cp} = {α}_{m} {p}_{i} {z}_{m} {T}_{c m} + {α}_{m} {w}_{m} {T}_{cp} & ( 4 )\end{matrix}$$

The normalization equation for the single level tree with intelligent root can be written as:

α₀+α₁+α₂+ . . . +αₘ=1 (5)

This gives m+1 linear equations with m+1 unknowns.

For a multi-level fat tree with intelligent root following the same load distribution policy, as shown in FIG. 2, the normalization equation for each level j (equivalent to a single level tree) can be written as:

αₒ^{j}+α₁^{j}+α₂^{j}+ . . . +αₘ^{j}=1j=1, 2, . . . (6)

Here αᵢ^{j} is the fraction of load that one of layer j's processor (one root node in level j) distributes to the i^{th} child processor.

Equations (2)-(4) can be re-written to yield a solution:

$${α}_{i} = ( \frac{{p}_{i} {z}_{i - 1} {T}_{c m} + {w}_{i - 1} {T}_{cp}}{{p}_{i} {z}_{i} {T}_{c m} + {w}_{i} {T}_{cp}} ) {α}_{i - 1} i = 2 , 3 , … , m \qquad ( 7 )$$

Let

$$\begin{matrix}{f}_{i - 1} = \frac{{p}_{i} {z}_{i - 1} {T}_{c m} + {w}_{i - 1} {T}_{cp}}{{p}_{i} {z}_{i} {T}_{c m} + {w}_{i} {T}_{cp}} \\ then & ( 8 ) \\ {α}_{i} = {f}_{i - 1} {α}_{i - 1} = ( {\prod }_{j = 1}^{i - 1} {f}_{j} ) {α}_{1} & ( 9 ) \\ = ( \frac{{p}_{i} {z}_{1} {T}_{c m} + {w}_{1} {T}_{cp}}{{p}_{i} {z}_{i} {T}_{c m} + {w}_{i} {T}_{cp}} ) {α}_{1} i = 2 , 3 , … , m & ( 10 )\end{matrix}$$

From equation (8), Π₁₌₁^{k}fₜ can be simplified as

$${\prod }_{t = 1}^{k} {f}_{t} = \frac{{p}_{i} {z}_{1} {T}_{c m} + {w}_{1} {T}_{cp}}{{p}_{i} {z}_{k + 1} {T}_{c m} + {w}_{k + 1} {T}_{cp}} k = 1 , 2 , … , m - 1 \qquad ( 11 )$$

To solve the set of equations, qᵢ is defined as:

$${q}_{i} = \frac{{w}_{o} {T}_{cp}}{{p}_{i} {z}_{1} {T}_{c m} + {w}_{1} {T}_{cp}} = \frac{{α}_{1}}{{α}_{0}} \qquad ( 12 )$$

If this equation is substituted into the normalization equation, the normalization equation becomes:

$$\frac{1}{{q}_{i}} {α}_{1} + {α}_{1} + {f}_{1} {α}_{1} + … + {f}_{1} {f}_{2} … {f}_{m - 1} {α}_{1} = 1 \qquad ( 13 )$$

Utilizing equation (11) and solving again for α₁:

$$\begin{matrix}{α}_{1} = \frac{1}{\frac{1}{{q}_{1}} + 1 + {\sum }_{k = 1}^{m - 1} ( {\prod }_{l = 1}^{k} {f}_{t} )} \\ = \frac{1}{\frac{1}{{q}_{i}} + 1 + ( {p}_{i} {z}_{1} {T}_{c m} + {w}_{1} {T}_{cp} ) \times {\sum }_{k = 1}^{m - 1} ( \frac{1}{{p}_{i} {z}_{k + 1} {T}_{c m} + {w}_{k + 1} {T}_{cp}} )} \\ = \frac{1}{\frac{1}{{q}_{i}} + ( {p}_{i} {z}_{1} {T}_{c m} + {w}_{1} {T}_{cp} ) \times {\sum }_{k = 0}^{m - 1} ( \frac{1}{{p}_{i} {z}_{k + 1} {T}_{c m} + {w}_{k + 1} {T}_{cp}} )}\end{matrix}$$

Accordingly,

$${α}_{0} = \frac{\frac{1}{{q}_{i}}}{\frac{1}{{q}_{i}} + ( {p}_{i} {z}_{1} {T}_{c m} + {w}_{1} {T}_{cp} ) \times {\sum }_{k = 0}^{m - 1} ( \frac{1}{{p}_{i} {z}_{k + 1} {T}_{c m} + {w}_{k + 1} {T}_{cp}} )} \qquad ( 14 )$$

More generally, defining Πⱼ₌₁⁰fⱼ1, then

$${α}_{i} = \frac{{\prod }_{j = 1}^{i - 1} {f}_{j} }{\frac{1}{{q}_{i}} + ( {p}_{i} {z}_{1} {T}_{c m} + {w}_{1} {T}_{cp} ) \times {\sum }_{k = 0}^{m - 1} ( \frac{1}{{p}_{i} {z}_{k + 1} {T}_{c m} + {w}_{k + 1} {T}_{cp}} )} \qquad ( 15 )$$

for i=1, 2, . . . , m.

From FIG. 4, the finish time at which a solution is achieved is:

$${T}_{f , m} = {α}_{1} ( {p}_{i} {z}_{1} {T}_{c m} + {w}_{1} {T}_{cp} ) = \frac{{p}_{i} {z}_{1} {T}_{c m} + {w}_{1} {T}_{cp}}{\frac{1}{{q}_{1}} + ( {p}_{i} {z}_{1} {T}_{c m} + {w}_{1} {T}_{cp} ) \times {\sum }_{k = 0}^{m - 1} ( \frac{1}{{p}_{i} {z}_{k + 1} {T}_{c m} + {w}_{k + 1} {T}_{cp}} )} \qquad ( 16 )$$

As a special case, consider the situation of a homogeneous network where all children processors have the same inverse computing speed and all links have the same inverse transmission speed (i.e. wᵢ=w and zᵢ=z for i=1, 2, . . . , m). Therefore, from (8), fᵢ is equal to 1, (for i=1, 2, . . . , m−1). Note for the root wₒ can be different from wᵢ.

For a single level tree, let T_{f,0}^{h} be the solution time for the entire divisible load solved on the root processor and let T_{f,m}^{h} be the solution time solved on the whole tree.

$${T}_{f , 0}^{h} = {α}_{o} {w}_{o} {T}_{cp} Here , {α}_{0} = 1 \\ {T}_{f , m}^{h} = ( \frac{1}{\frac{1}{{q}_{i}} + m} ) ( {p}_{i} {zT}_{cm} + {wT}_{cp} ) \qquad ( 17 )$$

Consequently,

$$\begin{matrix}Speedup = \frac{{T}_{f , 0}^{h}}{{T}_{f , m}^{h}} = \frac{{w}_{0} {T}_{cp}}{{p}_{i} {zT}_{cm} + {wT}_{cp}} ( \frac{1}{{q}_{i}} + m ) \\ = {q}_{i} ( \frac{1}{{q}_{i}} + m ) = 1 + {q}_{i} m\end{matrix} \qquad ( 18 )$$

Here, speedup is the effective processing gain in using m+1 processors. According to an embodiment of the present invention, the speedup of the single level homogeneous tree is equal to Θ(m), which is proportional to the number of children, per node m. Speedup is linear as long as the root CPU can concurrently (simultaneously) transmit load to all of its children. That is, the speedup of the single level tree does not saturate (in contrast to a sequential load distribution).

For a homogenous multi-level fat tree network where all processors have the same inverse computing speed, w, and links of level i+1 have the transmission speed, pᵢz, (see FIG. 2).

$${p}_{i} z = [ {( {\sum }_{j = 0}^{i} {m}^{j} )}^{- 1} ] z \qquad ( 19 )$$

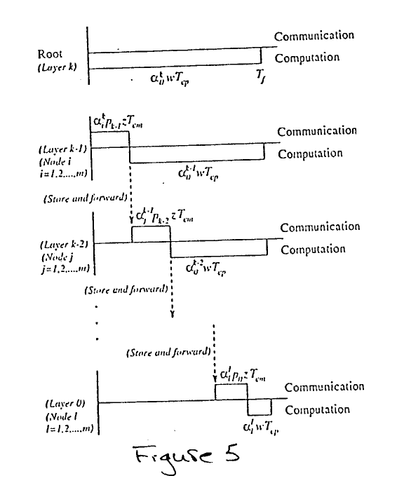

The process of load distribution for the multi-level fat tree network using store and forward switching for computing and communicating can be represented by Gantt chart-like timing diagrams, as shown in FIG. 5.

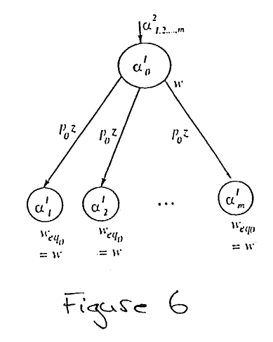

The method of determining optimal load distribution for a multi-level tree is now described. For the lowest single level tree, level 1, as shown in FIG. 6, the inverse computational speed of an equivalent processor is defined as w_{eq1}. This is a valid concept as the model is a linear one, as in a Norton's equivalent queue. Therefore, from equation (12) and (17), the computation time of level 1 can be written as:

$${w}_{eq1} {T}_{cp} = \frac{{p}_{0} {zT}_{cm} + {wT}_{cp}}{\frac{1}{{q}_{0} + m}} \qquad ( 20 )$$

for q₀=wT_{cp}/(P₀zT_{cm}+wT_{cp}).

Letσ=zT_{cm}/wT_{cp}, then

$$\frac{1}{{q}_{0}} = 1 + {p}_{o} σ \qquad ( 21 )$$

If w_{eq0} is defined as w, γ₀ can be defined as w_{eq}_{₀}/w=1. Hence, equation (21) can be transformed to:

1/q₀=1+p₀σ=γ₀+p₀σ (22)

An expression for an equivalent processor can be determined having the same load processing characteristics as the entire homogeneous fat tree. According to an embodiment of the present invention, each of the lowest most single level tree networks, level 1, is replaced with an equivalent processor. Proceeding recursively up the tree, each of the current lowest most single level subtrees is replaced with an equivalent processor. This continues until the entire homogeneous fat tree network is replaced by a single equivalent processor, with inverse proceeding speed w_{eqk}. Here, k, is the k^{th} level. Levels here are numbered from the bottom level upwards. In terms of notation, this is done from level 1 (this is the two bottom most layers), level 2 (currently next bottom most two layers), up to the top level (top two layers), (see FIG. 2).

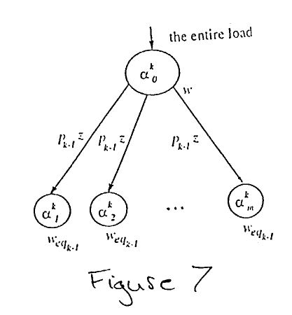

Note that for the entire initial (1^{st}) level equivalent processor replacement, both parent and children processors have the same inverse speed w, as shown in FIG. 6. At the k^{th} level, (equivalent to a single level tree), the parent will have inverse speed, w, and its children will have equivalent speed W_{eq}_{ₖ₋₁}, as shown in FIG. 7. Referring to equation (20) and (22), the equivalent computation time for the 1^{st} level can be defined as:

$${w}_{eq1} {T}_{cp} = \frac{{p}_{0} {zT}_{cm} + {wT}_{cp}}{m + {γ}_{0} + {p}_{0} σ} \qquad ( 23 )$$

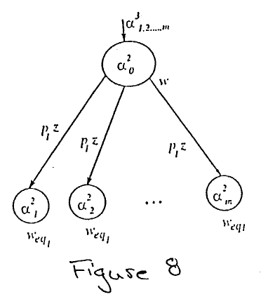

For level 2, as shown in FIG. 8, the equivalent inverse computational speed is defined as w_{eq2}. Therefore, from equation (17), the computation time

$${w}_{eq2} {T}_{cp} = \frac{{p}_{1} {zT}_{cm} + {w}_{eq1} {T}_{cp}}{\frac{1}{{q}_{1}} + m} \qquad ( 24 )$$

Here, from equation (12), wₒ=w, and w₁₌w₂= . . . wₘ=W_{eq1},

$${q}_{1} = \frac{{wT}_{cp}}{{p}_{1} {zT}_{cm} + {w}_{eq1} {T}_{cp}} \qquad ( 25 )$$

Let γ₁=w_{eq1}/w, then

$$\frac{1}{{q}_{1}} = \frac{{w}_{eq1}}{w} + {p}_{1} σ = {γ}_{1} + {p}_{1} σ \qquad ( 26 )$$

Referring to equation (24), the equivalent computation time of level 2 is given as follows:

$${w}_{eq2} {T}_{cp} = \frac{{p}_{1} {zT}_{cm} + {w}_{eq1} {T}_{cp}}{m + {γ}_{1} + {p}_{1} σ} \qquad ( 27 )$$

Therefore, the equivalent equation of a k^{th} level subtree, (see FIG. 2), for the equivalent computation time is

$${w}_{{eq}_{k}} {T}_{cp} = \frac{{p}_{k - 1} {zT}_{cm} + {w}_{{eq}_{k - 1}} {T}_{cp}}{m + {γ}_{k - 1} + {p}_{k - 1} σ} \qquad ( 28 )$$

Referring to equation (28),

$$\begin{matrix}{γ}_{k} = \frac{{w}_{{eq}_{k}}}{w} = \frac{{w}_{{eq}_{k}} {T}_{cp}}{{wT}_{cp}} \\ & \\ = \frac{{γ}_{k - 1} + {p}_{k - 1} σ}{m + {γ}_{k - 1} + {p}_{k - 1} σ} & ( 29 ) \\ = \frac{{γ}_{k - 1} + {( {\sum }_{j = 0}^{k - 1} {m}^{j} )}^{- 1} σ}{m + {γ}_{k - 1} + {( {\sum }_{j = 0}^{k - 1} {m}^{j} )}^{- 1} σ} & ( 30 )\end{matrix}$$

Consequently, γₖ is a recursive function. The value, 1/γₖ, is the speedup of a multi-level fat tree network with concurrent load distribution on each level and with store and forward computation and communication from level to level.

Let T_{f,o}^{e} be the equivalent solution time for the entire divisible load solved on only one processor and let T_{f,m}^{e,k} be the equivalent solution time of a whole homogeneous k-level fat tree network, on which each level has m children processors as well as the root processor. Then,

T_{f,o}^{e}=1·wT_{cp} the entire load=1

T_{f,m}^{e,k}=1·w_{eq}_{ₖ}T_{cp} the entire load=1

Consequently,

Speedup=

$$\begin{matrix}= \frac{{T}_{f , o}^{e}}{{T}_{f , m}^{e , k}} = \frac{{wT}_{cp}}{{w}_{{eq}_{k}} {T}_{cp}} = \frac{w}{{w}_{{eq}_{k}}} \\ = \frac{1}{{γ}_{k}} \\ = \frac{m + {γ}_{k - 1} + {( {\sum }_{j = 0}^{k - 1} {m}^{j} )}^{- 1} σ}{{γ}_{k - 1} + {( {\sum }_{j = 0}^{k - 1} {m}^{j} )}^{- 1} σ} & ( 31 ) \\ = 1 + \frac{m}{{γ}_{k - 1} + {( {\sum }_{j = 0}^{k - 1} {m}^{j} )}^{- 1} σ} & ( 32 )\end{matrix}$$

If m=1 and pᵢ=1, this model is the same as an linear network with store and forward switching.

If m=2, this model is a binary fat tree. If m=3, this model is a ternary fat tree.

If pᵢ=1, this model is not a fat tree. Each link in this model has the same transmission speed.

If (Σⱼ₌₀ⁱ⁻¹m^{j})⁻¹σ approaches to zero, the model approaches an ideal case. Each node can receive the load instantly and compute the data immediately. In such assumption, the recursive function (30) can be simplified as

$${γ}_{k} = \frac{{γ}_{k - 1}}{m + {γ}_{k - 1}} \qquad ( 32 )$$

A closed form solution is

$$\begin{matrix}{γ}_{k} = \frac{1}{{m}^{0} + {m}^{1} + {m}^{2} + … {m}^{k}} & ( 34 ) \\ Speedup = {\sum }_{j = 0}^{k} {m}^{1} & ( 35 )\end{matrix}$$

peedup is proportional to the total number of nodes, which is m⁰+m¹+m²+ . . . +m^{k}. Note, from (33), we can derive

$$Speedup = \frac{1}{{γ}_{k}} = 1 + m ( \frac{1}{{γ}_{k - 1}} ) \qquad ( 36 )$$

This equation expresses that the speedup of k-level fat tree is the sum of the speedup of root and all the speedup from m children. The speedup of k-level equivalent tree is Θ(m), which is proportional to the number of children, per node m. The number of levels of a tree increases, the speedup will approach a linear function. Therefore, saturation will be delayed compared to sequential distribution.

Note that the use of Kim type scheduling (H. -J. Kim, “A Novel Optimal Load Distribution Alogrithm for Divisible Loads,” Cluster Computing, vol. 6, no. 1, 2003, pp. 41-46), where processing at a child node commences as soon as load begins to be received, can be analyzed in a similar manner to that described here. Performance should improve somewhat because of the expedited computing in this case.

Two important points are confirmed by the present invention. Firstly, up to the limit of CPU speed, concurrent load distribution for a single level tree leads to a linear speedup as a function of the number of children. Secondly, the use of store and forward load distribution for a fat tree leads to a speedup approaching a linear speedup.

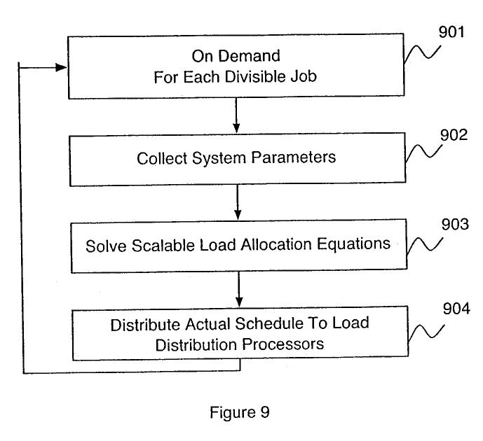

Referring to FIG. 9, a method according to an embodiment of the present invention is shown. In block 901, the method is initialized, such that, for each divisible job the system parameters are collected 902, the scalable load allocation is determined 903 and the schedule is distributed to load distribution processors 904. System parameters can include the network topology, a determined intensity for a given job communication/computation, and the available individual processors/link speeds.

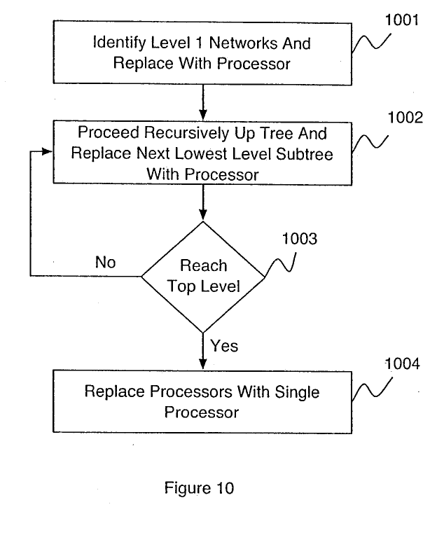

Referring to FIG. 10, according to an embodiment of the present invention, a fat tree network is processed, wherein level 1 networks are identified and replaced with an equivalent processor 1001. Each level in the tree is recursively visited, wherein each level is replaced with an equivalent processor 1002. The method determines whether a top level has been reached 1003 and if not continues the recursion. If the top level has been reached then it is replaced with a single processor 1004.

An equivalent processor is a processor that can replace a part of network or sub-network, and provides the same processing characteristics as the part of the network it replaces. Both single level tree networks and multi-level tree networks can be replaced by an equivalent processor. In determining the processing characteristics of such equivalent processors, the processing characteristics of the original single level and/or multi-level tree networks is also described. Specifically this approach is used to determine the solution time provided by such networks as well as their speedup and demonstrates the scalability of the scheduling policy(s).

Having described embodiments for a load distribution controller and method for scheduling metacomputers in a scalable manner, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for scalably scheduling a processing task in a tree network, comprising the steps of:
collecting system parameters;
scalably scheduling load allocations of the processing task;
distributing, simultaneously, scheduled load to one or more processors from a root processor;
processing scheduled load on the one or more processors; and
reporting results of a processed schedule load to the root processor.

2. The method of claim 1, wherein system parameters comprise network topology.

3. The method of claim 1, wherein system parameters comprise an intensity of the processor task, wherein the processor task comprises one of a computation task and a communication task.

4. The method of claim 1, wherein system parameters comprise a determined number of individual processors available.

5. The method of claim 1, wherein system parameters comprise a determined link speed between levels.

6. The method of claim 1, wherein system parameters comprise a determined processor speed between levels.

7. The method of claim 1, wherein the step of scalably scheduling load allocations of the task comprises:
identifying a lowest level of the tree network; and
replacing the lowest level with an equivalent processor.

8. The method of claim 1, wherein the step of scalably scheduling load allocations of the task comprises:
identifying each level of the tree network recursively up the tree network;
replacing each level upon identification with an equivalent processor; and
replacing the equivalent processors with a single processor upon identification of a root processors.

9. A program storage device readable by machine, tangibly embodying a program of instructions executable by the machine to perform method steps for scalably scheduling a processing task in a tree network, the method steps comprising:
collecting system parameters;
scalably scheduling load allocations of the processing task;
distributing, simultaneously, scheduled load to one or more processors from a root processor;
processing scheduled load on the one or more processors; and
reporting results of a processed schedule load to the root processor.

10. The method of claim 9, wherein system parameters comprise network topology.

11. The method of claim 9, wherein system parameters comprise an intensity of the processor task, wherein the processor task comprises one of a computation task and a communication task.

12. The method of claim 9, wherein system parameters comprise a determined number of individual processors available.

13. The method of claim 9, wherein system parameters comprise a determined link speed between levels.

14. The method of claim 9, wherein system parameters comprise a determined processor speed between levels.

15. The method of claim 9, wherein the step of scalably scheduling load allocations of the task comprises:
identifying a lowest level of the tree network; and
replacing the lowest level with an equivalent processor.

16. The method of claim 9, wherein the step of scalably scheduling load allocations of the task comprises:
identifying each level of the tree network recursively up the tree network;
replacing each level upon identification with an equivalent processor; and
replacing the equivalent processors with a single processor upon identification of a root processors.

17. A tree network having has m+1 processors and m links, comprising:
a plurality of children processors; and
an intelligent root, connected to each of the children processor via the links, for receiving a divisible load, partitioning a total processing load into m+1 fractions, keeping a fraction, and distributing remaining fractions to the children processors concurrently.

18. The tree network of claim 17, wherein each processor begins computing upon receiving a distributed fraction of the divisible load.

19. The tree network of claim 18, wherein each processor computes without any interruption until all of the distributed fraction of the divisible load has been processed.

20. The tree network of claim 18, wherein all of the processors in the tree network finish computing at the same time.
